(19) United States
(12) Patent Application Publication
(10) Pub. No.: US 2018/0282605 A1
(43) Pub. Date: Oct. 4, 2018

(54) METHOD OF MONITORING A PARAMETER OF A HYDROCARBON WELL, PIPELINE OR FORMATION

(71) Applicant: JOHNSON MATTHEY PUBLIC LIMITHED COMPANY, London (GB)

(72) Inventors: Neil BORRELL, Cleveland (GB); Aidan BRIERLEY, Cleveland (GB)

(73) Assignee: Johnson Matthey Public Limited Company, London (GB)

(21) Appl. No.: 15/765,754

(22) PCT Filed: Oct. 5, 2016
(86) PCT No.: PCT/GB2016/053099

§ 371 Date: Apr. 4, 2018

(30) Foreign Application Priority Data
Oct. 7, 2015 (GB) 1517745.4

(51) Int. Cl. C09K 8/035; E21B 47/10; C09K 8/58; E21B 49/00

(52) U.S. Cl. CPC C09K 8/035; E21B 49/003; C09K 8/58; E21B 47/1015

(57) ABSTRACT

A method of monitoring a parameter of a hydrocarbon well, pipeline or formation is provided. The method comprises introducing a tracer into the hydrocarbon well, pipeline or formation; producing a fluid from the hydrocarbon well, pipeline or formation; and analysing the fluid to determine if the tracer is present in the fluid. The tracer comprises a halogenated thiophene carboxylic or sulfonic acid or a salt of a halogenated thiophene carboxylic or sulfonic acid.

### FIELD OF THE INVENTION

The present invention relates to use of tracers in monitoring of hydrocarbon wells, pipelines or formations and methods of monitoring hydrocarbon wells, pipelines or formations. More specifically, but not exclusively, the invention relates to tracers for monitoring the relative production of water from different zones of hydrocarbon wells and methods of monitoring the relative production of water from different zones of hydrocarbon wells.

### BACKGROUND

The use of tracers to monitor aspects of the performance of hydrocarbon wells is an established technique. The tracers may be water tracers, in that they are predominantly soluble in water, oil tracers, in that they are soluble in the hydrocarbons in the formation, or partitioning tracers, in that they move between the water and hydrocarbon and back. Some tracing methods will more than one type of tracer and use the difference in behaviour to deduce properties of the hydrocarbon formation. For example, partitioning and water tracers may be injected into a production well along with injected water and then monitored as they are subsequently produced from the well. The time difference between the production of the water tracers, which are produced with the returning injected water, and the partitioning tracers, whose production is delayed by their interaction with the hydrocarbons in the formation, can be used to deduce parameters relating to the local remaining hydrocarbon content of the formation. Alternatively, applications may use only water tracers. For example, water tracers may be introduced in an injection well and their presence monitored at adjacent production wells in order to obtain information about the flux of water from the injection well to the production well.

In addition to injected techniques, it is also known to introduce tracers into a well by including them in articles placed into the well. For example, the tracers may be mixed with a polymer and cast into an article that is inserted into the well when the well is constructed. The tracer is then eluted from the polymer over time as fluid flows past the article. By detecting the rate of tracer production over time, information can be deduced about production of water or oil in the reservoir.

Examples of tracer techniques are described in EP1277051 and U.S. Pat. No. 8,640,773.

Many tracing techniques measure a property of a region of a well or formation relative to the properties of surrounding regions of the well or formation. In order to do that, different tracers are introduced into the different regions, whether by injection, placement during well construction, or another method. The production of each of the different tracers can be monitored in samples produced from the well to obtain information about where the produced fluids have come from. In addition, tracing techniques may be used sequentially on wells that have previously been traced. As an example, an inter-well tracer study may be used to monitor injected water flux from an injection well to a production well and a later study may then inject tracers into the same injection well or a different well to monitor the levels of hydrocarbon remaining in the well. If the same tracer is used for two different regions, or in two different studies, the analysis of the produced sample may be contaminated by tracer from the wrong region or the previous study. In a typical (“conventional”) well, there may be demand for studies involving 10-20 different tracers, but for some applications, for example hydraulic fracturing applications, it may be desirable to monitor as many as 40 different zones per lateral bore, with several laterals in a well. There is therefore a need for new tracers and in particular a need for new families of tracers.

Fluorinated benzoic acid salts are often used as water tracers in hydrocarbon well monitoring. A number of possible tracer variants exist in the fluorinated benzoic acid family since the benozoic acid can be mono-, di-, tri-, tetra- or penta-fluorinated and the fluorination can, except for the penta-fluorinated case, be at various locations on the aromatic ring. Nevertheless, there are a finite number of variants of fluorinated benzoic acids.

In order to be useful as a tracer, a compound should be thermally stable in that it should be stable at the temperatures typically encountered in wells, which may be 60 to 90° C. Desirably, a tracer is stable in temperatures up to maybe 160 or 180° C. so as to permit use in high temperature wells. For a water tracer, the compound should be highly selective toward water over oil. The compound should also be detectable in very small quantities, preferably at levels of 10 ppb or lower and most preferably in the parts per trillion (ppt) range (that is, at levels less than 1 ppb). The levels are determined on a mass/mass basis. The compound should also be environmentally acceptable, for inserting into the ground, but also not a compound that is naturally present in the ground in such quantities as to contaminate the results of the tracer study.

Typical detection methods include gas chromatography-mass spectrometry (GC-MS), gas chromatography-mass spectrometry-mass spectrometry (GC-MS-MS), liquid chromatography-mass spectroscopy (LC-MS), liquid chromatography-mass spectroscopy-mass spectroscopy (LC-MS-MS) and high pressure liquid chromatography (HPLC), which can typically detect very low concentrations of the tracers in the produced fluids. It is desirable that tracers should be detectable in low quantities and also that they can be reliably distinguished from other tracers.

Further examples of tracers are disclosed in EP2563874.

Preferred embodiments of the present invention seek to overcome one or more of the above disadvantages of the prior art. In particular, preferred embodiments of the present invention seek to provide new tracer compounds for use in hydrocarbon well monitoring.

### SUMMARY OF INVENTION

According to a first aspect of the invention, there is provided use of a tracer in monitoring a parameter of a hydrocarbon well, pipeline or formation, the tracer comprising a halogenated thiophene carboxylic acid, a halogenated thiophene sulfonic acid, a salt of a halogenated thiophene carboxylic acid or a salt of a halogenated thiophene sulfonic acid. Preferably the tracer comprises a salt of a halogenated thiophene carboxylic acid or a salt of a halogenated thiophene sulfonic acid.

Preferably the tracer is a water tracer. Thus the use may involve monitoring the flow of water through or from a well or formation. For example the use may determine the source of produced water by introducing the tracer into a defined part of the well or formation and monitoring for the presence of the tracer in produced water. As another example, the use may involve a partitioning study to determine residual oil saturation where the tracer is used as the conservative, water soluble tracer.

Preferably the tracer comprises a compound, or a salt thereof, of formula 1:

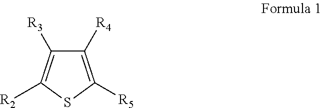

wherein at least one of R₂, R₃, R₄ and R₅ is carboxylic acid (—COOH) or sulfonic acid (—SO₃H),
wherein at least a further one of R₂, R₃, R₄ and R₅ is independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1,
and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

Thus an aspect of the invention provides use of a tracer in monitoring a parameter of a hydrocarbon well, pipeline or formation, the tracer comprising a compound, or a salt thereof, of formula 1:

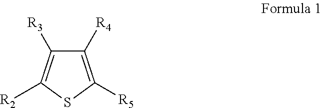

wherein at least one of R₂, R₃, R₄ and R₅ is carboxylic acid (—COOH) or sulfonic acid (—SO₃H),
wherein at least a further one of R₂, R₃, R₄ and R₅ is independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1,
and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

Preferably not more than 2 of R₂, R₃, R₄ and R₅ are carboxylic acid or sulfonic acid. In some embodiments exactly one of R₂, R₃, R₄ and R₅ is carboxylic acid or sulfonic acid. Such compounds may have good detectability. In some embodiments exactly two of R₂, R₃, R₄ and R₅ are carboxylic acid or sulfonic acid. Compounds with two acid groups (“di-acids”) may be more preferable than compounds with one acid group (“mono-acids”) due to their higher water selectivity. Preferably the acid groups on the compound are either all carboxylic acid or all sulfonic acid. In some embodiments the acid groups are carboxylic acid. Such embodiments may be advantageous due to the relative ease of handling of carboxylic acids. We have also found that halogenated thiophene carboxylates can have good detectability in water tracing applications. In some embodiments the acid groups are sulfonic acid. Such compounds may be advantageous for water tracing due to the high water solubility of the sulfonic acids and their salts.

Preferably at least a further two of R₂, R₃, R₄ and R₅ are independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1. In some embodiments, where there is only one acid group, it may be that a further three of R₂, R₃, R₄ and R₅ are independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1.

Preferably the at least a further one, or the at least a further two, or the a further three, of R₂, R₃, R₄ and R₅ is independently selected from the group consisting of F, Cl, CₙFₓCl_{y}H_{(2n+1-x-y)}, where n=1, 2 or 3, and x and y are integers such that 1≤x+y≤2n+1, and O—CₘFⱼClₖH₍₂ₘ₊₁₋ⱼ₋ₖ₎, where m=1, 2 or 3, and j and k are integers such that 1≤j+k≤2m+1. More preferably the at least a further one, or the at least a further two, or the a further three, of R₂, R₃, R₄ and R₅ is independently selected from the group consisting of F, Cl and CₙFₓCl_{y}H_{(2n+1-x-y)}, where n=1, 2 or 3, and x and y are integers such that 1≤x+y≤2n+1. It may be that the at least a further one, or the at least a further two, or the a further three, of R₂, R₃, R₄ and R₅ is independently selected from the group consisting of F, Cl and CₙXₓH₍₂ₙ₊₁₋ₓ₎ where n=1, 2 or 3, 1≤x≤2n+1 and X is one of F, Cl or Br and preferably one of F or Cl. Most preferably the at least a further one, or the at least a further two, or the a further three, of R₂, R₃, R₄ and R₅ is independently selected from the group consisting of F and Cl. In some embodiments the at least a further one, or the at least a further two, or the a further three, of R₂, R₃, R₄ and R₅ is independently selected from the group consisting of F, Cl, Br, CFH₂, CF₂H and CF₃, and in some embodiments the at least a further one, or the at least a further two, or the a further three, of R₂, R₃, R₄ and R₅ is independently selected from the group consisting of F, Cl and Br.

Preferably the remainder of R₂, R₃, R₄ and R₅ are independently selected from the group consisting of H, CH₃, C₂H₅ and C₃H₇. More preferably the remainder of R₂, R₃, R₄ and R₅ are independently selected from the group consisting of H and CH₃.

The invention concerns the use of halogenated thiophene carboxylic acids or halogenated thiophene sulfonic acids, or salts of either, in tracing applications in hydrocarbon wells. Such compounds are not naturally found in hydrocarbon wells and formations and have not been previously used as tracers in such wells and formations. Tracers comprising such compounds may therefore be used as tracers in such wells and formations without the results of the tracing being affected by contamination. Moreover, the applicant has determined that non-halogenated thiophene compounds exist naturally in hydrocarbon formations and the compounds of the invention are therefore expected to be sufficiently stable, for example to have sufficient thermal stability, to survive the conditions in a hydrocarbon well. Since, unlike the naturally occurring thiophene compounds, the compounds of formula 1 are halogenated they are advantageously also detectable, for example using GC-MS, in very low concentrations, for example concentrations of 1 ppb or less, preferably concentrations of 100 ppt or less, more preferably concentrations of 10 ppt or less and yet more preferably concentrations of 1 ppt or less. The compounds of the invention may also show a high selectivity towards water instead of oil. Thus the tracer may be a water tracer. The compound may have a log P value of less than −1. The log P value is a well-known value for characterising the preference of a compound for water or oil. The value is the log of the ratio of the equilibrium concentration of the compound in oil (octanol) to the equilibrium concentration of the compound in water. Thus the concentration of the compound in water is preferably at least 10 times, and more preferably at least 100 times, that of the compound in oil. It may be that the salt of the compound (or the anion of the salt) is more soluble in water than the acid. For that reason, it is preferable to use the salt as the tracer. Representative example values for log P of anions are in the table below.

| | |
|---|---|
| 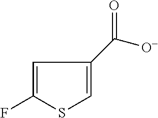 | −1.81 |
| 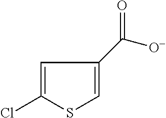 | −1.35 |
| 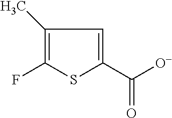 | −1.16 |
| 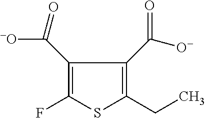 | −4.59 |

It can be seen that the mono-acid anions have sufficient preference for water to act as reliable water tracers, even when halogenated and methylated. The advantage of the di-acids, or their salts, for water tracing applications is also demonstrated since the log P value of the di-acid anion is very low, even with an ethyl substituent increasing the size of the anion. The di-acids and their salts may therefore be particularly advantageous since a number of different tracers can be produced by altering the substituent groups, for example using alkoxy or alkyl substituents, while retaining a strong preference for water over oil. The tracer may therefore comprise a compound, or a salt thereof, of formula 1:

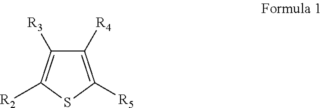

wherein two of R₂, R₃, R₄ and R₅ are carboxylic acid (—COOH) or sulfonic acid (—SO₃H), wherein at least a further one of R₂, R₃, R₄ and R₅ is independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1, and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3. Preferably two of R₂, R₃, R₄ and R₅ are carboxylic acid (—COOH) or sulfonic acid (—SO₃H), a further one of R₂, R₃, R₄ and R₅ is selected from the group consisting of consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1 and the remaining one of R₂, R₃, R₄ and R₅ is selected from the group consisting of H, CₛH₍₂ₛ₊₁₎, where s=1, 2 or 3, and O—CₜH₍₂ₜ₊₁₎, where t=1, 2 or 3. Preferably two of R₂, R₃, R₄ and R₅ are carboxylic acid (—COOH) or sulfonic acid (—SO₃H), a further one of R₂, R₃, R₄ and R₅ is selected from the group consisting of consisting of F, Cl and Br and the remaining one of R₂, R₃, R₄ and R₅ is selected from the group consisting of H, CₛH₍₂ₛ₊₁₎, where s=1, 2 or 3, and O—CₜH₍₂ₜ₊₁₎, where t=1, 2 or 3.

Compounds of the invention may be particularly advantageous in that the compounds are based on halogenated thiophene sulfonic acids or halogenated thiophene carboxylic acids. The thiophene-based structure results in a clear distinction between the tracers of the invention and prior art tracers based upon fluorinated benzoic acids when analysed using GC-MS. Moreover, the compounds exhibit good thermal stability and selectivity to water over oil. Thus the provision of halogenated thiophene sulfonic acid or halogenated thiophene carboxylic acid derived family of tracers results in a new family of tracer compounds that are distinguishable from each other and from previously used tracer compounds. That may be advantageous in all hydrocarbon well, pipeline or formation tracing applications, but may be particularly advantageous in the tracing of fracking wells, where large quantities of individually distinguishable tracers may be required for even a single tracing study. The tracers of the invention advantageously have detectability equivalent to previously used water tracers.

The parameter monitored may be a parameter related to a property, such as flow or composition, of the well, pipeline or formation and may be an absolute parameter or a relative parameter. A relative parameter may describe a property of one part of the well, pipeline or formation relative to another part. Examples of parameters that may be monitored include a relative distribution of water production along a lateral or between laterals in multiple interconnected well systems, a formation fluid composition, or a measure of rock heterogeneity. Preferably, the parameter relates to a well or formation. It will be appreciated that when a parameter is said to relate to a well or formation, that well refers to the constructed apparatus for extracting the hydrocarbon, while formation refers to the natural structure in which the hydrocarbon is located and from which it is extracted via the well.

According to a second aspect of the invention there is provided a method of monitoring a parameter of a hydrocarbon well, pipeline or formation, the method comprising:
introducing a tracer into the hydrocarbon well, pipeline or formation;
producing a fluid from the hydrocarbon well, pipeline or formation; and
analysing the fluid to determine if the tracer is present in the fluid;
characterised in that the tracer comprises a halogenated thiophene carboxylic acid, a halogenated thiophene sulfonic acid, a salt of a halogenated thiophene carboxylic acid or a salt of a halogenated thiophene sulfonic acid.

Preferably the tracer comprises a compound, or a salt thereof, of formula 1:

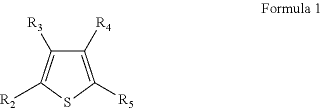

wherein at least one of R₂, R₃, R₄ and R₅ is carboxylic acid (—COOH) or sulfonic acid (—SO₃H),
wherein at least a further one of R₂, R₃, R₄ and R₅ is selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1,
and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

Thus an aspect of the invention provides a method of monitoring a parameter of a hydrocarbon well, pipeline or formation, the method comprising:
introducing a tracer into the hydrocarbon well, pipeline or formation;
producing a fluid from the hydrocarbon well, pipeline or formation; and
analysing the fluid to determine if the tracer is present in the fluid;
characterised in that the tracer comprises a compound, or a salt thereof, of formula 1:

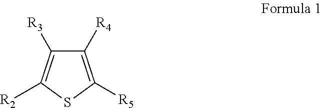

wherein at least one of R₂, R₃, R₄ and R₅ is carboxylic acid (—COOH) or sulfonic acid (—SO₃H),
wherein at least a further one of R₂, R₃, R₄ and R₅ is selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1,
and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

The analysis may be qualitative, in that it determines whether the tracer is present or not, or it may be quantitative in that it determines if the tracer is present by determining the level, for example the concentration, of the tracer in the fluid. Thus the method may comprise determining the concentration of the tracer in the fluid.

Further aspects of the tracer may be as set out above for the tracer of the first aspect of the invention.

The method may monitor a parameter of a hydrocarbon well or formation. The tracer may be introduced into the well by any method. For example, the introducing may comprise injecting the tracer into the well or formation. For example, the tracer may be injected into the well or formation of which the parameter is being monitored. The tracer may be injected into an adjacent well or formation and thus be introduced into the formation via the adjacent well or formation. The tracer may be introduced into the well or formation during construction of the well. For example, the tracer may be provided comprised in a solid article incorporated into or attached to a component part of the well, such as a filter, mesh, sand screen, in-flow control device or valve. The tracer may be introduced into the well or formation as a liquid, for example in solution or as an emulsion with injection fluid, such as drilling fluids, hydraulic fracturing fluids or injection water. The tracer may be introduced into the well as a solid, for example as slurry with drilling fluids, hydraulic fracturing fluids or injection water, or as a solid or liquid encapsulated in another solid. The tracer may be introduced into the well or formation by introducing a proppant which comprises the tracer.

The fluid produced may comprise water, for example the fluid may comprise a mixture of hydrocarbon and water. The analysing may be performed on-line, at-line or off-line. In the latter cases, samples of the fluid may be taken and transferred to a laboratory, either at the drilling location (at-line) or at a remote location (off-line) for analysis. Preferably the analysing is carried out using GC-MS. An advantage of the method of the invention may be that the tracer comprising a compound (or a salt thereof) of formula 1 may be readily distinguishable from prior art tracers, many of which now already contaminate a large number of wells and formation, using GC-MS.

The analysis may be qualitative, in that it determines whether the tracer is present or not, or it may be quantitative in that it determines if the tracer is present by determining the level, for example the concentration, of the tracer in the fluid. Preferably the analysis determines the level at which the tracer is present in the fluid. The level may be determined as a ratio of parts of tracer per part of fluid for example. Thus the method may comprise determining the concentration of the tracer in the fluid.

The tracer may comprise a halogenated thiophene carboxylic acid. The tracer may comprise a halogenated thiophene sulfonic acid. The tracer may comprise a salt of a halogenated thiophene carboxylic acid. The tracer may comprise a salt of halogenated thiophene sulfonic acid. Preferably the salt is a sodium salt. Preferably the tracer comprises a salt, preferably a sodium salt, of a compound of formula 1. The tracer may consist of the acid or a salt thereof. The acid itself, or a salt thereof, may be the tracer.

It will be appreciated that the acid or the salt may dissociate to form an anion when dissolved in water. The anion may therefore act as the tracer when the acid or salt is dissolved. When the tracer is said to comprise the acid or salt it will be understood as encompassing the situation in which the anion of the dissolved acid or salt may act as the tracer. The analysis of the fluid for the tracer may analyse for the tracer in its dissolved state, or may involve steps of extracting the tracer and subsequently analysing the extracted tracer. It will be appreciated that the analysis method may include steps that convert, for example, a tracer salt to the corresponding acid or anion, or to both, as part of the analysis method. For example, when a halogenated thiophene carboxylate salt is used as the tracer, the salt may be present in a dissociated form in the fluid produced from the well and the analysing of the fluid to determine if the tracer is present in the fluid may involve a GC-MS analysis of the fluid that includes steps of converting the salt into the corresponding carboxylic acid and a final mass spectrometry step that detects the corresponding anion in the mass spectrometer. Nevertheless, the halogenated thiophene carboxylate salt will be understood as being the tracer and being detected by the analysis method.

Examples of halogenated thiophene carboxylic acid tracers embodying the invention include: 3-chlorothiophene-2-carboxylic acid, 4-chlorothiophene-2-carboxylic acid, 5-chlorothiophene-2-carboxylic acid, 3,4-dichlorothiophene-2-carboxylic acid, 3,5-dichlorothiophene-2-carboxylic acid, 4,5-dichlorothiophene-2-carboxylic acid, 3,4,5-trichlorothiophene-2-carboxylic acid, 3-fluorothiophene-2-carboxylic acid, 4-fluorothiophene-2-carboxylic acid, 5-fluorothiophene-2-carboxylic acid, 3,4-difluorothiophene-2-carboxylic acid, 3,5-difluorothiophene-2-carboxylic acid, 4,5-difluorothiophene-2-carboxylic acid, 3,4,5-trifluorothiophene-2-carboxylic acid, 3-fluoro-4-chlorothiophene-2-carboxylic acid, 3-chloro-4-fluorothiophene-2-carboxylic acid, 3-fluoro-5-chlorothiophene-2-carboxylic acid, 3-chloro-5-fluorothiophene-2-carboxylic acid, 4-fluoro-5-chlorothiophene-2-carboxylic acid, 4-chloro-5-fluorothiophene-2-carboxylic acid, 3-fluoro-4,5-dichlorothiophene-2-carboxylic acid, 3-chloro-4,5-difluorothiophene-2-carboxylic acid, 3,5-difluoro-4-chlorothiophene-2-carboxylic acid, 3,5-dichloro-4-fluorothiophene-2-carboxylic acid, 3,4-difluoro-5-chlorothiophene-2-carboxylic acid, 3,4-dichloro-5-fluorothiophene-2-carboxylic acid, 2-chlorothiophene-3-carboxylic acid, 4-chlorothiophene-3-carboxylic acid, 5-chlorothiophene-3-carboxylic acid, 2,4-dichlorothiophene-3-carboxylic acid, 2,5-dichlorothiophene-3-carboxylic acid, 4,5-dichlorothiophene-3-carboxylic acid, 2,4,5-trichlorothiophene-3-carboxylic acid, 2-fluorothiophene-3-carboxylic acid, 4-fluorothiophene-3-carboxylic acid, 5-fluorothiophene-3-carboxylic acid, 2,4-difluorothiophene-3-carboxylic acid, 2,5-difluorothiophene-3-carboxylic acid, 4,5-difluorothiophene-3-carboxylic acid, 2,4,5-trifluorothiophene-3-carboxylic acid, 2-fluoro-4-chlorothiophene-3-carboxylic acid, 2-chloro-4-fluorothiophene-3-carboxylic acid, 2-fluoro-5-chlorothiophene-3-carboxylic acid, 2-chloro-5-fluorothiophene-3-carboxylic acid, 4-fluoro-5-chlorothiophene-3-carboxylic acid, 4-chloro-5-fluorothiophene-3-carboxylic acid, 2-fluoro-4,5-dichlorothiophene-3-carboxylic acid, 2-chloro-4,5-difluorothiophene-3-carboxylic acid, 2,5-difluoro-4-chlorothiophene-3-carboxylic acid, 2,5-dichloro-4-fluorothiophene-3-carboxylic acid, 2,4-difluoro-5-chlorothiophene-3-carboxylic acid, 2,4-dichloro-5-fluorothiophene-3-carboxylic acid, 3-chlorothiophene-2,5-dicarboxylic acid, 3,4-dichlorothiophene-2,5-dicarboxylic acid, 3-fluorothiophene-2,5-dicarboxylic acid, 3,4-difluorothiophene-2,5-dicarboxylic acid, 3-fluoro-4-chlorothiophene-2,5-dicarboxylic acid, 3-chlorothiophene-2,4-dicarboxylic acid, 5-chlorothiophene-2,4-dicarboxylic acid, 3,5-dichlorothiophene-2,4-dicarboxylic acid, 3-fluorothiophene-2,4-dicarboxylic acid, 5-fluorothiophene-2,4-dicarboxylic acid, 3,5-difluorothiophene-2,4-dicarboxylic acid, 3-fluoro-5-chlorothiophene-2,4-dicarboxylic acid, 3-chloro-5-fluorothiophene-2,4-dicarboxylic acid, 2-chlorothiophene-3,4-dicarboxylic acid, 2,5-dichlorothiophene-3,4-dicarboxylic acid, 2-fluorothiophene-3,4-dicarboxylic acid, 2,5-difluorothiophene-3,4-dicarboxylic acid, 2-fluoro-5-chlorothiophene-3,4-dicarboxylic acid, 2-chlorothiophene-3,4,5-tricarboxylic acid, 2-fluorothiophene-3,4,5-tricarboxylic acid, 3-chlorothiophene-2,4,5-tricarboxylic acid and 3-fluorothiophene-2,4,5-tricarboxylic acid.

Examples of halogenated thiophene sulfonic acid tracers embodying the invention include: 3-chlorothiophene-2-sulfonic acid, 4-chlorothiophene-2-sulfonic acid, 5-chlorothiophene-2-sulfonic acid, 3,4-dichlorothiophene-2-sulfonic acid, 3,5-dichlorothiophene-2-sulfonic acid, 4,5-dichlorothiophene-2-sulfonic acid, 3,4,5-trichlorothiophene-2-sulfonic acid, 3-fluorothiophene-2-sulfonic acid, 4-fluorothiophene-2-sulfonic acid, 5-fluorothiophene-2-sulfonic acid, 3,4-difluorothiophene-2-sulfonic acid, 3,5-difluorothiophene-2-sulfonic acid, 4,5-difluorothiophene-2-sulfonic acid, 3,4,5-trifluorothiophene-2-sulfonic acid, 3-fluoro-4-chlorothiophene-2-sulfonic acid, 3-chloro-4-fluorothiophene-2-sulfonic acid, 3-fluoro-5-chlorothiophene-2-sulfonic acid, 3-chloro-5-fluorothiophene-2-sulfonic acid, 4-fluoro-5-chlorothiophene-2-sulfonic acid, 4-chloro-5-fluorothiophene-2-sulfonic acid, 3-fluoro-4,5-dichlorothiophene-2-sulfonic acid, 3-chloro-4,5-difluorothiophene-2-sulfonic acid, 3,5-difluoro-4-chlorothiophene-2-sulfonic acid, 3,5-dichloro-4-fluorothiophene-2-sulfonic acid, 3,4-difluoro-5-chlorothiophene-2-sulfonic acid, 3,4-dichloro-5-fluorothiophene-2-sulfonic acid, 2-chlorothiophene-3-sulfonic acid, 4-chlorothiophene-3-sulfonic acid, 5-chlorothiophene-3-sulfonic acid, 2,4-dichlorothiophene-3-sulfonic acid, 2,5-dichlorothiophene-3-sulfonic acid, 4,5-dichlorothiophene-3-sulfonic acid, 2,4,5-trichlorothiophene-3-sulfonic acid, 2-fluorothiophene-3-sulfonic acid, 4-fluorothiophene-3-sulfonic acid, 5-fluorothiophene-3-sulfonic acid, 2,4-difluorothiophene-3-sulfonic acid, 2,5-difluorothiophene-3-sulfonic acid, 4,5-difluorothiophene-3-sulfonic acid, 2,4,5-trifluorothiophene-3-sulfonic acid, 2-fluoro-4-chlorothiophene-3-sulfonic acid, 2-chloro-4-fluorothiophene-3-sulfonic acid, 2-fluoro-5-chlorothiophene-3-sulfonic acid, 2-chloro-5-fluorothiophene-3-sulfonic acid, 4-fluoro-5-chlorothiophene-3-sulfonic acid, 4-chloro-5-fluorothiophene-3-sulfonic acid, 2-fluoro-4,5-dichlorothiophene-3-sulfonic acid, 2-chloro-4,5-difluorothiophene-3-sulfonic acid, 2,5-difluoro-4-chlorothiophene-3-sulfonic acid, 2,5-dichloro-4-fluorothiophene-3-sulfonic acid, 2,4-difluoro-5-chlorothiophene-3-sulfonic acid, 2,4-dichloro-5-fluorothiophene-3-sulfonic acid, 3-chlorothiophene-2,5-disulfonic acid, 3,4-dichlorothiophene-2,5-disulfonic acid, 3-fluorothiophene-2,5-disulfonic acid, 3,4-difluorothiophene-2,5-disulfonic acid, 3-fluoro-4-chlorothiophene-2,5-disulfonic acid, 3-chlorothiophene-2,4-disulfonic acid, 5-chlorothiophene-2,4-disulfonic acid, 3,5-dichlorothiophene-2,4-disulfonic acid, 3-fluorothiophene-2,4-disulfonic acid, 5-fluorothiophene-2,4-disulfonic acid, 3,5-difluorothiophene-2,4-disulfonic acid, 3-fluoro-5-chlorothiophene-2,4-disulfonic acid, 3-chloro-5-fluorothiophene-2,4-disulfonic acid, 2-chlorothiophene-3,4-disulfonic acid, 2,5-dichlorothiophene-3,4-disulfonic acid, 2-fluorothiophene-3,4-disulfonic acid, 2,5-difluorothiophene-3,4-disulfonic acid, 2-fluoro-5-chlorothiophene-3,4-disulfonic acid, 2-chlorothiophene-3,4,5-trisulfonic acid, 2-fluorothiophene-3,4,5-trisulfonic acid, 3-chlorothiophene-2,4,5-trisulfonic acid and 3-fluorothiophene-2,4,5-trisulfonic acid.

Examples of halogenated thiophene carboxylate tracer salts embodying the invention include: 3-chlorothiophene-2-carboxylate, 4-chlorothiophene-2-carboxylate, 5-chlorothiophene-2-carboxylate, 3,4-dichlorothiophene-2-carboxylate, 3,5-dichlorothiophene-2-carboxylate, 4,5-dichlorothiophene-2-carboxylate, 3,4,5-trichlorothiophene-2-carboxylate, 3-fluorothiophene-2-carboxylate, 4-fluorothiophene-2-carboxylate, 5-fluorothiophene-2-carboxylate, 3,4-difluorothiophene-2-carboxylate, 3,5-difluorothiophene-2-carboxylate, 4,5-difluorothiophene-2-carboxylate, 3,4,5-trifluorothiophene-2-carboxylate, 3-fluoro-4-chlorothiophene-2-carboxylate, 3-chloro-4-fluorothiophene-2-carboxylate, 3-fluoro-5-chlorothiophene-2-carboxylate, 3-chloro-5-fluorothiophene-2-carboxylate, 4-fluoro-5-chlorothiophene-2-carboxylate, 4-chloro-5-fluorothiophene-2-carboxylate, 3-fluoro-4,5-dichlorothiophene-2-carboxylate, 3-chloro-4,5-difluorothiophene-2-carboxylate, 3,5-difluoro-4-chlorothiophene-2-carboxylate, 3,5-dichloro-4-fluorothiophene-2-carboxylate, 3,4-difluoro-5-chlorothiophene-2-carboxylate, 3,4-dichloro-5-fluorothiophene-2-carboxylate, 2-chlorothiophene-3-carboxylate, 4-chlorothiophene-3-carboxylate, 5-chlorothiophene-3-carboxylate, 2,4-dichlorothiophene-3-carboxylate, 2,5-dichlorothiophene-3-carboxylate, 4,5-dichlorothiophene-3-carboxylate, 2,4,5-trichlorothiophene-3-carboxylate, 2-fluorothiophene-3-carboxylate, 4-fluorothiophene-3-carboxylate, 5-fluorothiophene-3-carboxylate, 2,4-difluorothiophene-3-carboxylate, 2,5-difluorothiophene-3-carboxylate, 4,5-difluorothiophene-3-carboxylate, 2,4,5-trifluorothiophene-3-carboxylate, 2-fluoro-4-chlorothiophene-3-carboxylate, 2-chloro-4-fluorothiophene-3-carboxylate, 2-fluoro-5-chlorothiophene-3-carboxylate, 2-chloro-5-fluorothiophene-3-carboxylate, 4-fluoro-5-chlorothiophene-3-carboxylate, 4-chloro-5-fluorothiophene-3-carboxylate, 2-fluoro-4,5 dichlorothiophene-3-carboxylate, 2-chloro-4,5 difluorothiophene-3-carboxylate, 2,5-difluoro-4-chlorothiophene-3-carboxylate, 2,5-dichloro-4-fluorothiophene-3-carboxylate, 2,4-difluoro-5-chlorothiophene-3-carboxylate, 2,4-dichloro-5-fluorothiophene-3-carboxylate, 3-chlorothiophene-2,5-dicarboxylate, 3,4-dichlorothiophene-2,5-dicarboxylate, 3-fluorothiophene-2,5-dicarboxylate, 3,4-difluorothiophene-2,5-dicarboxylate, 3-fluoro-4-chlorothiophene-2,5-dicarboxylate, 3-chlorothiophene-2,4-dicarboxylate, 5-chlorothiophene-2,4-dicarboxylate, 3,5-dichlorothiophene-2,4-dicarboxylate, 3-fluorothiophene-2,4-dicarboxylate, 5-fluorothiophene-2,4-dicarboxylate, 3,5-difluorothiophene-2,4-dicarboxylate, 3-fluoro-5-chlorothiophene-2,4-dicarboxylate, 3-chloro-5-fluorothiophene-2,4-dicarboxylate, 2-chlorothiophene-3,4-dicarboxylate, 2,5-dichlorothiophene-3,4-dicarboxylate, 2-fluorothiophene-3,4-dicarboxylate, 2,5-difluorothiophene-3,4-dicarboxylate, 2-fluoro-5-chlorothiophene-3,4-dicarboxylate, 2-chlorothiophene-3,4,5-tricarboxylate, 2-fluorothiophene-3,4,5-tricarboxylate, 3-chlorothiophene-2,4,5-tricarboxylate and 3-fluorothiophene-2,4,5-tricarboxylate. For example the carboxylate may be a sodium carboxylate.

Examples of halogenated thiophene sulfonate tracer salts embodying the invention include: 3-chlorothiophene-2-sulfonate, 4-chlorothiophene-2-sulfonate, 5-chlorothiophene-2-sulfonate, 3,4-dichlorothiophene-2-sulfonate, 3,5-dichlorothiophene-2-sulfonate, 4,5-dichlorothiophene-2-sulfonate, 3,4,5-trichlorothiophene-2-sulfonate, 3-fluorothiophene-2-sulfonate, 4-fluorothiophene-2-sulfonate, 5-fluorothiophene-2-sulfonate, 3,4-difluorothiophene-2-sulfonate, 3,5-difluorothiophene-2-sulfonate, 4,5-difluorothiophene-2-sulfonate, 3,4,5-trifluorothiophene-2-sulfonate, 3-fluoro-4-chlorothiophene-2-sulfonate, 3-chloro-4-fluorothiophene-2-sulfonate, 3-fluoro-5-chlorothiophene-2-sulfonate, 3-chloro-5-fluorothiophene-2-sulfonate, 4-fluoro-5-chlorothiophene-2-sulfonate, 4-chloro-5-fluorothiophene-2-sulfonate, 3-fluoro-4,5-dichlorothiophene-2-sulfonate, 3-chloro-4,5-difluorothiophene-2-sulfonate, 3,5-difluoro-4-chlorothiophene-2-sulfonate, 3,5-dichloro-4-fluorothiophene-2-sulfonate, 3,4-difluoro-5-chlorothiophene-2-sulfonate, 3,4-dichloro-5-fluorothiophene-2-sulfonate, 2-chlorothiophene-3-sulfonate, 4-chlorothiophene-3-sulfonate, 5-chlorothiophene-3-sulfonate, 2,4-dichlorothiophene-3-sulfonate, 2,5-dichlorothiophene-3-sulfonate, 4,5-dichlorothiophene-3-sulfonate, 2,4,5-trichlorothiophene-3-sulfonate, 2-fluorothiophene-3-sulfonate, 4-fluorothiophene-3-sulfonate, 5-fluorothiophene-3-sulfonate, 2,4-difluorothiophene-3-sulfonate, 2,5-difluorothiophene-3-sulfonate, 4,5-difluorothiophene-3-sulfonate, 2,4,5-trifluorothiophene-3-sulfonate, 2-fluoro-4-chlorothiophene-3-sulfonate, 2-chloro-4-fluorothiophene-3-sulfonate, 2-fluoro-5-chlorothiophene-3-sulfonate, 2-chloro-5-fluorothiophene-3-sulfonate, 4-fluoro-5-chlorothiophene-3-sulfonate, 4-chloro-5-fluorothiophene-3-sulfonate, 2-fluoro-4,5-dichlorothiophene-3-sulfonate, 2-chloro-4,5-difluorothiophene-3-sulfonate, 2,5-difluoro-4-chlorothiophene-3-sulfonate, 2,5-dichloro-4-fluorothiophene-3-sulfonate, 2,4-difluoro-5-chlorothiophene-3-sulfonate, 2,4-dichloro-5-fluorothiophene-3-sulfonate, 3-chlorothiophene-2,5-disulfonate, 3,4-dichlorothiophene-2,5-disulfonate, 3-fluorothiophene-2,5-disulfonate, 3,4 difluorothiophene-2,5-disulfonate, 3-fluoro-4-chlorothiophene-2,5-disulfonate, 3-chlorothiophene-2 4-disulfonate, 5-chlorothiophene-2,4-disulfonate, 3,5-dichlorothiophene-2,4-disulfonate, 3-fluorothiophene-2,4-disulfonate, 5-fluorothiophene-2,4-disulfonate, 3,5-difluorothiophene-2,4-disulfonate, 3-fluoro-5-chlorothiophene-2,4-disulfonate, 3-chloro-5-fluorothiophene-2,4-disulfonate, 2-chlorothiophene-3,4-disulfonate, 2,5-dichlorothiophene-3,4-disulfonate, 2-fluorothiophene-3,4-disulfonate, 2,5-difluorothiophene-3,4-disulfonate, 2-fluoro-5-chlorothiophene-3,4-disulfonate, 2-chlorothiophene-3,4,5-trisulfonate, 2-fluorothiophene-3,4,5-trisulfonate, 3-chlorothiophene-2,4,5-trisulfonate and 3-fluorothiophene-2,4,5-trisulfonate. For example the sulfonate may be a sodium sulfonate.

Other examples of compounds embodying the invention include: 3-methoxy-5-fluorothiophene-2-carboxylic acid, 4-methoxy-5-chlorothiophene-2-carboxylic acid, 3-methoxy-4-fluorothiophene-2,5-dicarboxylic acid, 3-methyl-5-fluorothiophene-2-carboxylic acid, 4-methyl-5-chlorothiophene-2-carboxylic acid, 2-ethyl-5-fluorothiophene-3,4-dicarboxylic acid and 3-propyl-4-fluorothiophene-2,5-dicarboxylic acid.

Other examples of compounds embodying the invention include: 3-methoxy-5-fluorothiophene-2-sulfonic acid, 4-methoxy-5-chlorothiophene-2-sulfonic acid, 3-methoxy-4-fluorothiophene-2,5-disulfonic acid, 3-methyl-5-fluorothiophene-2-sulfonic acid, 4-methyl-5-chlorothiophene-2-sulfonic acid, 2-ethyl-5-fluorothiophene-3,4-disulfonic acid and 3-propyl-4-fluorothiophene-2,5-disulfonic acid.

Other examples of compounds embodying the invention include: 3-methoxy-5-fluorothiophene-2-carboxylate, 4-methoxy-5-chlorothiophene-2-carboxylate, 3-methoxy-4-fluorothiophene-2,5-dicarboxylate, 3-methyl-5-fluorothiophene-2-carboxylate, 4-methyl-5-chlorothiophene-2-carboxylate, 2-ethyl-5-fluorothiophene-3,4-dicarboxylate and 3-propyl-4-fluorothiophene-2,5-dicarboxylate.

Other examples of compounds embodying the invention include: 3-methoxy-5-fluorothiophene-2-sulfonate, 4-methoxy-5-chlorothiophene-2-sulfonate, 3-methoxy-4-fluorothiophene-2,5-disulfonate, 3-methyl-5-fluorothiophene-2-sulfonate, 4-methyl-5-chlorothiophene-2-sulfonate, 2-ethyl-5-fluorothiophene-3,4-disulfonate and 3-propyl-4-fluorothiophene-2,5-disulfonate.

It will be appreciated that features described in relation to one aspect of the invention may be equally applicable in another aspect of the invention. For example, features described in relation to the use of the tracer of the invention, may be equally applicable to the method of the invention, and vice versa. Some features may not be applicable to, and may be excluded from, particular aspects of the invention.

### DESCRIPTION OF THE DRAWINGS

Embodiments of the present invention will now be described, by way of example, and not in any limitative sense, with reference to the accompanying drawings, of which:

FIG. 1 is a GC-MS plot for a selection of tracers.

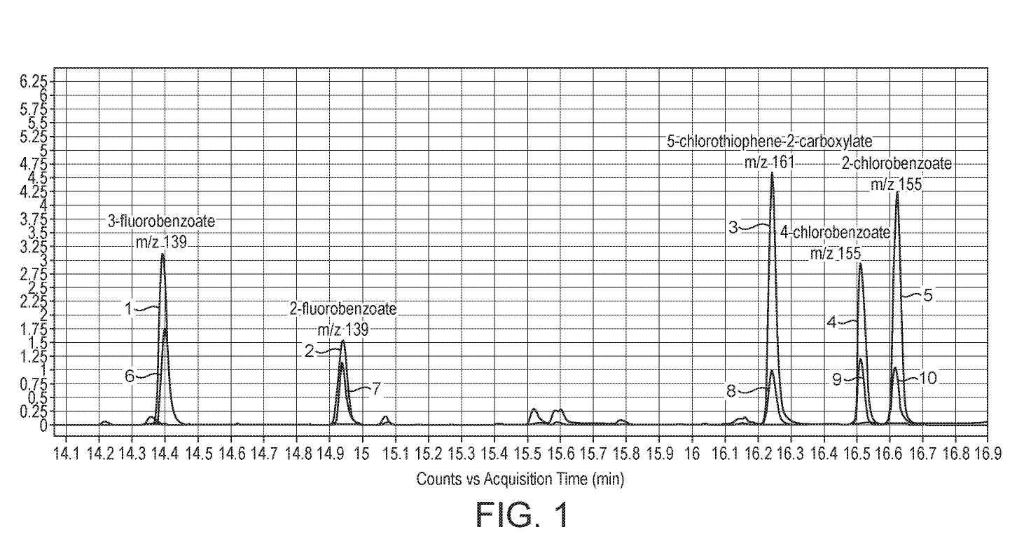

In FIG. 1 a GC-MS plot shows the counts versus acquisition time for various m/z ions resulting from a selection of tracers according to the prior art and according to the present invention. The individual peaks 1, 2, 3, 4, and 5 are obtained from individual samples of 3-fluorobenzoate, 2-fluorobenzoate, 5-chlorothiophene-2-carboxylate, 4-chlorobenzoate and 2-chlorobenzoate respectively. The lower peaks 5, 7, 8, 9 and 10 relate to the same salts detected in a single sample containing all the salts in approximately equal concentrations. It can be seen that the peaks 3 and 8 relating to the 5-chlorothiophene-2-carboxylate tracer according to the present invention are clearly distinguishable from the peaks 1, 2, 4, 5, 6, 7, 9 and 10 relating to the prior art tracers. Other tracers according to the invention are similarly distinguishable.

It will be appreciated by persons skilled in the art that the above embodiments have been described by way of example only, and not in any limitative sense, and that various alterations and modifications are possible without departure from the scope of the invention as defined by the appended claims.

1. A method of monitoring a parameter of a hydrocarbon well, pipeline or formation, the method comprising:
introducing a tracer into the hydrocarbon well, pipeline or formation;
producing a fluid from the hydrocarbon well, pipeline or formation; and
analysing the fluid to determine if the tracer is present in the fluid;
wherein the tracer comprises a halogenated thiophene carboxylic or sulfonic acid or a salt of a halogenated thiophene carboxylic or sulfonic acid.

2. (canceled)

3. The method according to claim 1, wherein the tracer comprises a salt of a halogenated thiophene carboxylic or sulfonic acid.

4. The method according to claim 1, wherein the tracer comprises a compound, or a salt thereof, of formula 1: 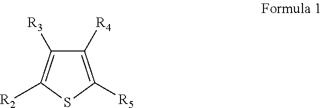
wherein at least one of R₂, R₃, R₄ and R₅ is carboxylic acid or sulfonic acid,
wherein at least a further one of R₂, R₃, R₄ and R₅ is independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1,
and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

5. The method according to claim 4, wherein not more than two of R₂, R₃, R₄ and R₅ are carboxylic acid or sulfonic acid.

6. The method according to claim 5, wherein exactly one of R₂, R₃, R₄ and R₅ is carboxylic acid or sulfonic acid.

7. The method according to claim 5, wherein exactly two of R₂, R₃, R₄ and R₅ is carboxylic acid or sulfonic acid.

8. The method according to claim 7, wherein two of R₂, R₃, R₄ and R₅ are carboxylic acid or sulfonic acid, wherein at least a further one of R₂, R₃, R₄ and R₅ is independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1, and wherein the remainder of R₂, R₃, R₄ and R₅ are independently selected from the group consisting of H, CₛH₍₂ₛ₊₁₎, where s=1, 2 or 3, and O—CₜH₍₂ₜ₊₁₎, where t=1, 2 or 3.

9. The method according to claim 8, wherein two of R₂, R₃, R₄ and R₅ are carboxylic acid or sulfonic acid, a further one of R₂, R₃, R₄ and R₅ is selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1 and the remaining one of R₂, R₃, R₄ and R₅ is selected from the group consisting of H, CₛH₍₂ₛ₊₁₎, where s=1, 2 or 3, and O—CₜH₍₂ₜ₊₁₎, where t=1, 2 or 3.

10. The method according to claim 8, wherein two of R₂, R₃, R₄ and R₅ are carboxylic acid or sulfonic acid, a further one of R₂, R₃, R₄ and R₅ is selected from the group consisting of F, Cl, and Br and the remaining one of R₂, R₃, R₄ and R₅ is selected from the group consisting of H, CₛH₍₂ₛ₊₁₎, where s=1, 2 or 3, and 0-CₜH₍₂ₜ₊₁₎, where t=1, 2 or 3.

11. The method according to claim 4, wherein at least two of R₂, R₃, R₄ and R₅ are independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1.

12. The method according to claim 11, wherein three of R₂, R₃, R₄ and R₅ are independently selected from the group consisting of F, Cl, Br, CₙFₓCl_{y}Br_{z}H_{(2n+1-x-y-z)}, where n=1, 2 or 3, and x, y and z are integers such that 1≤x+y+z≤2n+1, and O—CₘFⱼClₖBrₗH₍₂ₘ₊₁₋ⱼ₋ₖ₋ₗ₎, where m=1, 2 or 3, and j, k and l are integers such that 1≤j+k+l≤2m+1.

13. The method according to claim 4, wherein the at least a further one of R₂, R₃, R₄ and R₅ is independently selected from the group consisting of F, Cl, CₙFₓCl_{y}H_{(2n+1-x-y)}, where n=1, 2 or 3, and x and y are integers such that 1≤x+y≤2n+1, and O—CₘFⱼClₖH₍₂ₘ₊₁₋ⱼ₋ₖ₎, where m=1, 2 or 3, and j and k are integers such that 1≤j+k≤2m+1.

14. The method according to claim 13, wherein the at least a further one is independently selected from the group consisting of F, Cl and CₙFₓCl_{y}H_{(2n+1-x-y)}, where n=1, 2 or 3, and x and y are integers such that 1≤x+y≤2n+1.

15. The method according to claim 4, wherein the at least a further one of R₂, R₃, R₄ and R₅ is independently selected from the group consisting of F, Cl and CₙXₓH₍₂ₙ₊₁₋ₓ₎ where n=1, 2 or 3, 1≤x≤2n+1 and X is one of F, Cl or Br.

16. The method according to claim 15, wherein X is one of F or Cl.

17. The method according to claim 4, wherein the at least a further one of R₂, R₃, R₄ and R₅ is independently selected from the group consisting of F, Cl, Br, CFH₂, CF₂H and CF₃.

18. The method according to claim 17, wherein the at least a further one of R₂, R₃, R₄ and R₅ is independently selected from the group consisting of F, Cl and Br.

19. The method according to claim 18, wherein the at least a further one of R₂, R₃, R₄ and R₅ is independently selected from the group consisting off and Cl.

20. The method according to claim 4, wherein the remainder of R₂, R₃, R₄ and R₅ are independently selected from the group consisting of H, CH₃, C₂H₅ and C₃H₇.

21. The method according to claim 1, wherein the tracer comprises a sodium salt.

22. The method according to claim 11, wherein the at least a further one or the at least two of R₂, R₃, R₄ and R₅ is independently selected from the group consisting of F, Cl, CₙFₓCl_{y}H_{(2n+1-x-y)}, where n=1, 2 or 3, and x and y are integers such that 1≤x+y≤2n+1, and O—CₘFⱼClₖH₍₂ₘ₊₁₋ⱼ₋ₖ₎, where m=1, 2 or 3, and j and k are integers such that 1≤j+k≤2m+1.

23. The method according to claim 22, wherein the at least a further one or the at least two of R₂, R₃, R₄ and R₅ is independently selected from the group consisting of F, Cl and CₙFₓCl_{y}H_{(2n+1-x-y)}, where n=1, 2 or 3, and x and y are integers such that 1≤x+y≤2n+1.

24. The method according to claim 11, wherein the at least a further one or the at least two of R₂, R₃, R₄ and R₅ is independently selected from the group consisting of F, Cl and CₙXₓH₍₂ₙ₊₁₋ₓ₎ where n=1, 2 or 3, 1≤x≤2n+1 and X is one of F, Cl or Br.

25. The method according to claim 24, wherein X is one of F or Cl.

26. The method according to claim 11, wherein the at least a further one or the at least two of R₂, R₃, R₄ and R₅ is independently selected from the group consisting of F, Cl, Br, CFH₂, CF₂H and CF₃.

27. The method according to claim 26, wherein the at least a further one or the at least two is independently selected from the group consisting of F, Cl and Br.

28. The method according to claim 27, wherein the at least a further one or the at least two is independently selected from the group consisting of F and Cl.

29. The method according to claim 12, wherein the at least a further one, the at least two, or the three of R₂, R₃, R₄ and R₅ is independently selected from the group consisting of F, Cl, CₙFₓCl_{y}H_{(2n+1-x-y)}, where n=1, 2 or 3, and x and y are integers such that 1≤x+y≤2n+1, and O—CₘFⱼClₖH₍₂ₘ₊₁₋ⱼ₋ₖ₎, where m=1, 2 or 3, and j and k are integers such that 1≤j+k≤2m+1.

30. The method according to claim 29, wherein the at least a further one, the at least two, or the three of R₂, R₃, R₄ and R₅ is independently selected from the group consisting of F, Cl and CₙFₓCl_{y}H_{(2n+1-x-y)}, where n=1, 2 or 3, and x and y are integers such that 1≤x+y≤2n+1.

31. The method according to claim 12, wherein the at least a further one, the at least two, or the three of R₂, R₃, R₄ and R₅ is independently selected from the group consisting of F, Cl and CₙXₓH₍₂ₙ₊₁₋ₓ₎ where n=1, 2 or 3, 1≤x≤2n+1 and X is one of F, Cl or Br.

32. The method according to claim 31, wherein X is one of F or Cl.

33. The method according to claim 12, wherein the at least a further one, the at least two, or the three of R₂, R₃, R₄ and R₅ is independently selected from the group consisting of F, Cl, Br, CFH₂, CF₂H and CF₃.

34. The method according to claim 33, wherein the at least a further one, the at least two, or the three of R₂, R₃, R₄ and R₅ is independently selected from the group consisting of F, Cl and Br.

35. The method according to claim 34, wherein the at least a further one, the at least two, or the three of R₂, R₃, R₄ and R₅ is independently selected from the group consisting of F and Cl.
